(19) United States
(12) Patent Application Publication
(10) Pub. No.: US 2009/0156340 A1
(43) Pub. Date: Jun. 18, 2009

(54) VARIABLE TENSIONER

(75) Inventor: Suengwoo Seo, Seoul (KR)

Correspondence Address: MORGAN, LEWIS & BOCKIUS LLP (SF), One Market, Spear Street Tower, Suite 2800, San Francisco, CA, 94105, US

(73) Assignees: Hyundai Motor Company, Seoul (KR); Kia Motors Corporation, Seoul (KR)

(21) Appl. No.: 12/183,906

(22) Filed: Jul. 31, 2008

(30) Foreign Application Priority Data
Dec. 14, 2007 (KR) 10-2007-0131560

(51) Int. Cl. F16H 7/10

(52) U.S. Cl. 474/113

(57) ABSTRACT

A variable tensioner according to an exemplary embodiment of the present invention may include: a base, an arm including a boss and a mounting portion, wherein the boss is co-axially and rotatably coupled to the base and a pulley is coaxially and rotatably mounted to the mounting portion, the arm forming an elastic member insert recess with the base, an elastic member mounted in the elastic member insert recess, one end of the elastic member fixed to the base and the other end of the elastic member fixed to the boss, and a tension actuator deforming a portion of the elastic member according to signal of an engine control unit.

### CROSS-REFERENCE TO RELATED APPLICATION

This application claims priority to and the benefit of Korean Patent Application No. 10-2007-0131560 filed in the Korean Intellectual Property Office on Dec. 14, 2007, the entire contents of which are incorporated herein by reference.

### BACKGROUND OF THE INVENTION

(a) Field of the Invention

The present invention relates to a variable tensioner. More particularly, the present invention relates to a variable tensioner that reduces friction loss and improves fuel mileage and durability of a pulley and a belt as a consequence of controlling tension of the belt according to an engine speed.

(b) Description of the Related Art

Generally, auxiliary machines such as a camshaft, an alternator, a power steering pump, and an air conditioner compressor are connected to a crankshaft of an engine by a belt. Therefore, power of the crankshaft is transmitted to the auxiliary machines by frictional force of the belt.

In a case that tension of the belt is too strong, the frictional force of the belt may increase and friction loss may also increase. On the contrary, in a case that the tension of the belt is too weak, slip of the belt may occur and power delivery efficiency may be deteriorated.

Particularly, an integrated starter-generator is used in a hybrid vehicle in order to drive the hybrid vehicle at a starting or low engine speed. Since load of the integrated starter-generator is very high, there is high possibility for slip of the belt to occur, and accordingly it is required that the tension of the belt is more heightened.

However, the friction loss is very high and fuel mileage is very low because of high tension of the belt.

To solve such problems, two tensioners are generally mounted in the hybrid vehicle so as to control the tension of the belt. However, since two tensioners are used, the mounting structure of the belt may be complex and manufacturing cost of the hybrid vehicle may rise.

The above information disclosed in this Background section is only for enhancement of understanding of the background of the invention and therefore it may contain information that does not form the prior art that is already known in this country to a person of ordinary skill in the art.

### SUMMARY OF THE INVENTION

Embodiments of the present invention provide a variable tensioner having advantages of reducing friction loss and improving fuel mileage and durability of a pulley and a belt as a consequence of controlling tension of the belt according to an engine speed.

A variable tensioner according to an exemplary embodiment of the present invention may include a base, an arm including a boss and a mounting portion, wherein the boss is co-axially and rotatably coupled to the base and a pulley is coaxially and rotatably mounted to the mounting portion, the arm forming an elastic member insert recess with the base, an elastic member mounted in the elastic member insert recess, one end of the elastic member fixed to the base and the other end of the elastic member fixed to the boss, and a tension actuator deforming a portion of the elastic member according to signal of an engine control unit. The elastic member insert recess may be enclosed by the base and the boss.

In an exemplary embodiment of the present invention, the boss and the mounting portion of the arm may be integrally formed of a single body. The base and the boss may be coupled by a first connecting member, the base is fixed so that the boss is rotatable relative to the base, and the mounting portion and the pulley are coupled by a second connecting member. The first connecting member and the second connecting member may be offset with a predetermined distance. The first connecting member may be a shaft and the second connecting member may be a bolt. The elastic member may be wound substantially around the first connecting member.

The base may comprise an interior circumference, an exterior circumference, and a protruding portion configured to be disposed between the interior circumference and exterior circumference thereof, and the boss comprises an interior circumference and an exterior circumference wherein the exterior circumference of the boss protrudes downwardly and contacts the exterior circumference of the base and the interior circumference of the boss protrudes downwardly and a lower portion of the interior circumference of the boss is slidably inserted in a boss insert groove of the base formed between the interior circumference and protruding portion of the base. The elastic member insert recess may be disposed between the interior circumference and exterior circumference of the base and the interior circumference and exterior circumference of the boss. The elastic member may be wound substantially around the interior circumference of the base and the interior circumference of the boss in the elastic member insert recess.

In another exemplary embodiment of the present invention, the tension actuator may be provided with one end fixed to the base and the other end disposed in close proximity to a portion of the elastic member. The tension actuator may deform rotationally the portion of the elastic member so as to enforce torsion moment when the tension actuator is activated. The tension actuator may be a piezoelectric element.

The engine control unit may control the tension actuator in a case that the engine speed is less than or equal to a predetermined speed so as to extend the tension actuator. A crank shaft position sensor may detect the phase angle of a crankshaft and send the detected phase angle to the engine control unit to calculate the engine speed. The predetermined engine speed may be 2000 RPM.

### BRIEF DESCRIPTION OF THE DRAWINGS

FIG. 1 is a cross-sectional view of a variable tensioner according to an exemplary embodiment of the present invention.

FIG. 2 is a cross-sectional view taken along the line II-II in FIG. 1.

FIG. 3 is a graph showing a rotational vibration according to an engine speed.

### DETAILED DESCRIPTION OF THE EMBODIMENTS

An exemplary embodiment of the present invention will hereinafter be described in detail with reference to the accompanying drawings.

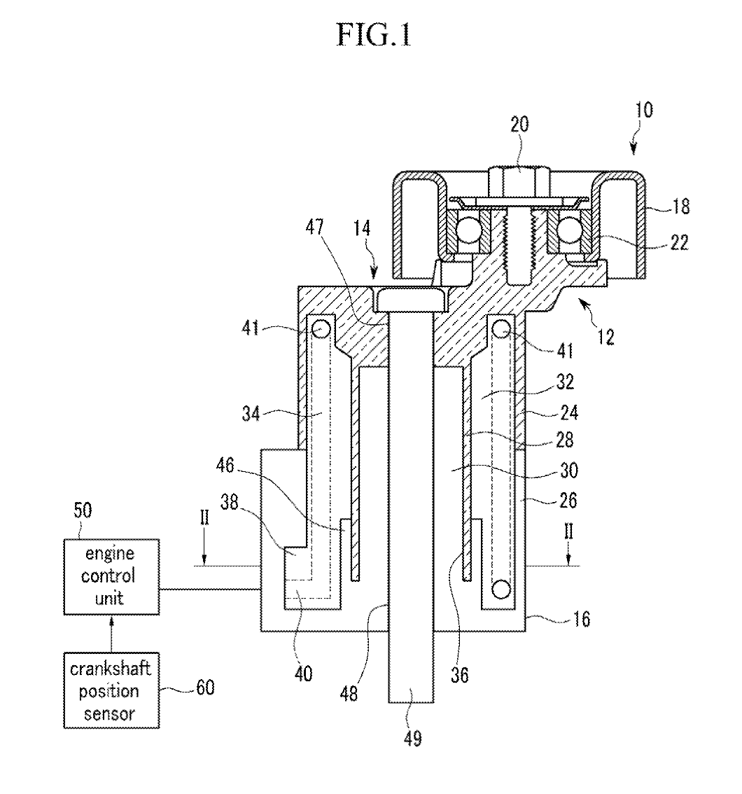

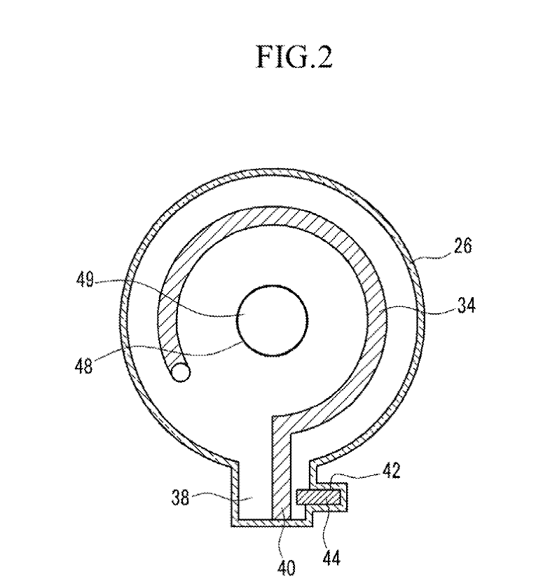

As shown in FIG. 1 and FIG. 2, a variable tensioner according to an exemplary embodiment of the present invention includes a base 16, an arm 10, an elastic member 34, an engine control unit 50, and a crankshaft position sensor 60.

The base 16 has a cylindrical shape, an upper end thereof is open, and a lower end thereof is closed. The base 16 is fixed. In addition, the base 16 includes an interior circumference 30 and an exterior circumference 26, and a protruding portion 46 that protrudes upwardly from the lower end thereof is formed between the interior circumference 30 and the exterior circumference 26.

The interior circumference 30 protrudes upwardly, and a first shaft insert hole 48 is formed substantially at a middle portion and in the longitudinal direction thereof. A boss insert groove 36 is formed between the interior circumference 30 and the protruding portion 46, and an elastic member insert recess 32 is disposed between the interior circumference 30 and the exterior circumference 26. In addition, an elastic member fixing groove 38 is formed at a lower portion of the elastic member insert recess 32, and one end 40 of the elastic member 34 is fixed to the elastic member fixing groove 38 of the base 16.

As shown in FIG. 2, a tension actuator insert groove 42 is formed in the elastic member fixing groove 38, and a tension actuator 44 is mounted in the tension actuator insert groove 42.

The tension actuator 44 controls tension of a belt by controlling elastic force of an elastic member 34. The tension actuator 44 is provided with two ends, wherein one end thereof is fixed to the tension actuator insert groove 42 of the base 16 and the other end thereof is disposed in close proximity to the elastic member 34. In addition, the tension actuator 44 is electrically connected to and is controlled by the engine control unit 50. The tension actuator 44 may be a piezoelectric element, and the engine control unit 50 controls operation of the tension actuator 44 by applying current to the tension actuator 44. Therefore, in an exemplary embodiment of the present invention, if the engine control unit 50 applies the current to the tension actuator 44, the tension actuator 44 is extended and pushes substantially the one end of the elastic member 34 so as to strengthen the elastic force and thus pull the elastic member 34 thereof as explained later in detail.

Referring to FIG. 1, the arm 10 includes a boss 14 and a mounting portion 12, and the boss 14 and the mounting portion 12 are integrally formed with each other.

The boss 14 has a cylindrical shape, an upper portion thereof is closed, and a lower portion thereof is open. In addition, the boss 14 includes an interior circumference 28 and an exterior circumference 24, and the elastic member insert recess 32 is formed between the interior circumference 28 and the exterior circumference 24. A second shaft insert hole 47 corresponding to the first shaft insert hole 48 is formed substantially at a middle portion of the boss 14 in the longitudinal direction thereof, and a shaft 49 is inserted through the first and second shaft insert holes 48 and 47 such that the boss 14 is rotatably connected to the base 16.

The exterior circumference 24 of the boss 14 protrudes downwardly and contacts the exterior circumference 26 of the base 16. The interior circumference 28 of the boss 14 protrudes downwardly and a lower portion of the interior circumference 28 is inserted in the boss insert groove 36 of the base 16. The interior circumference 28 of the boss 14 is slidably coupled to the boss insert groove 36 of the base 16.

A pulley 18 is coupled to the mounting portion 12 by a bolt 20, and a bearing 22 is interposed between the pulley 18 and the mounting portion 12. Therefore, the pulley 18 can rotate relative to the mounting portion 12. The belt is mounted on the pulley 18 such that the pulley 18 rotates together with a crankshaft (not shown). Furthermore the bolt 20 is offset from the shaft 49 with a predetermined distance.

However, in a case that tension of the belt is too strong, the frictional force of the belt may increase and friction loss may also increase and if the tension of the belt is too weak, slip of the belt may occur and power delivery efficiency may be deteriorated. To solve such problems, the position of the pulley 18 can be regulated so as to control the tension of the belt as explained hereinafter.

In an exemplary embodiment of the present invention, the elastic member 34 is wound around the interior circumference 28 of the boss 14 and the protruding portion 46 of the base 16 in the elastic member insert recess 32 formed by the boss 14 and the base 16. The one end 40 of the elastic member 34 is fixed to the base 16 in the elastic member fixing groove 38, and the other end 41 thereof is fixed to the boss 14 of the arm 10. Since the base 16 is fixed but the boss 14 can rotate relative to the base 16 around the shaft 49, the elastic member 34 elastically supports rotation of the arm 10 with torsion moment when the elastic member 34 is deformed by the torsion actuator 44.

The crankshaft position sensor 60 is mounted at the crankshaft (not shown), and detects phase angle of the crankshaft and transmits a signal corresponding thereto to the engine control unit 50. The engine control unit 50 calculates an engine speed from a change in the phase angle of the crankshaft detected by the crankshaft position sensor 60. Based on the calculated engine speed, the engine control unit 50 electrically connected to the tension actuator 44 applies the current thereto to control the position of the pulley 18.

The position of the pulley 18 can be controlled by rotation of the boss 14 since the bolt 20 is offset from the shaft 49 with a predetermined distance and the boss 44 and the mounting portion 12 is integrally formed.

Operation of the variable tensioner according to an exemplary embodiment of the present invention will be described in detail.

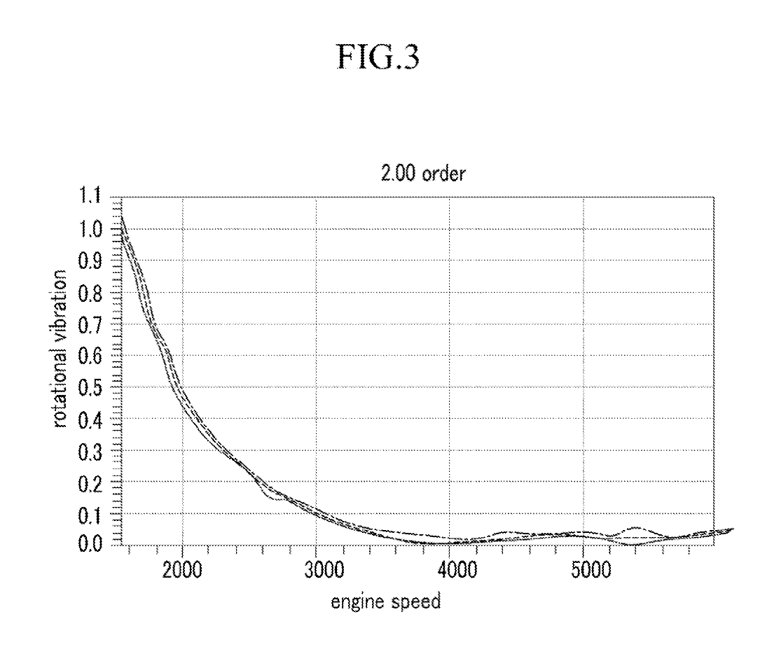

FIG. 3 is a graph showing a rotational vibration according to an engine speed.

As shown in FIG. 3, it can be known that rotational vibration generated at the engine is large in a case in which the engine speed is less than or equal to 2000 RPM. Therefore, it can be also known that the tension of the belt must be strong in a case in which the engine speed is less than or equal to 2000 RPM.

The engine control unit 50 receiving the signal corresponding to the phase angle of the crankshaft from the crankshaft position sensor 60 calculates the engine speed from the change in the phase angle of the crankshaft.

If the engine speed is less than or equal to a predetermined speed (e.g., 2000 RPM), the engine control unit 50 applies the current to the tension actuator 44 so as to extend it. In this case, the extended tension actuator 44 pushes a portion of the one end 40 of the elastic member 34 such that the elastic force of the elastic member 34 increases. Further since the base 16 is fixed but the boss 14 can rotate relative to the base 16 around the shaft 49, the elastic member 34 rotates clockwise in FIG. 2 as the elastic member 34 is deformed by the tension actuator 44. The rotation of the boss 14 is converted into a pivotal rotation of the pulley 18 since the bolt 20 is offset from the shaft 49 with a predetermined distance and the boss 44 and the mounting portion 12 is integrally formed. As a result, the pivotal rotation of the pulley 18 pulls the belt (not shown) and thus the tension of the belt increases.

If the engine speed is greater than the predetermined rotation speed, the engine control unit 50 does not apply the current to the tension actuator 44 and thereby the tension actuator 44 is restored to an original length thereof. Therefore, the elastic member 34 also is restored to the home position by the elastic force and torsion moment thereof stored as it was deformed. As a result the tension of the belt decreases due to the restoration of the elastic member 34.

As described above, the engine control unit 50 controls the tension of the belt by controlling the current applied to the tension actuator 44 according to the engine speed.

According to the present invention, friction loss may be reduced and fuel mileage may improve as a consequence of the tension of a belt being increased in a case of low engine speed where rotational vibration is strong and the tension of the belt being decreased in a case of high engine speed where the rotational vibration is weak.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A variable tensioner comprising:
a base;
an arm including a boss and a mounting portion, wherein the boss is co-axially and rotatably coupled to the base and a pulley is coaxially and rotatably mounted to the mounting portion, the arm forming an elastic member insert recess with the base;
an elastic member mounted in the elastic member insert recess, one end of the elastic member fixed to the base and the other end of the elastic member fixed to the boss; and
a tension actuator deforming a portion of the elastic member according to signal of an engine control unit.

2. The variable tensioner of claim 1, wherein the elastic member insert recess is enclosed by the base and the boss.

3. The variable tensioner of claim 1, wherein the boss and the mounting portion of the arm is integrally formed of a single body.

4. The variable tensioner of claim 3, wherein the base and the boss are coupled by a first connecting member, the base is fixed so that the boss is rotatable relative to the base, and the mounting portion and the pulley are coupled by a second connecting member.

5. The variable tensioner of claim 4, wherein the first connecting member and the second connecting member is offset with a predetermined distance.

6. The variable tensioner of claim 5, wherein the first connecting member is a shaft.

7. The variable tensioner of claim 5, wherein the second connecting member is a bolt.

8. The variable tensioner of claim 4, wherein the elastic member is wound substantially around the first connecting member.

9. The variable tensioner of claim 3, wherein the base comprises an interior circumference, an exterior circumference, and a protruding portion configured to be disposed between the interior circumference and exterior circumference thereof, and the boss comprises an interior circumference and an exterior circumference wherein the exterior circumference of the boss protrudes downwardly and contacts the exterior circumference of the base and the interior circumference of the boss protrudes downwardly and a lower portion of the interior circumference of the boss is slidably inserted in a boss insert groove of the base formed between the interior circumference and protruding portion of the base.

10. The variable tensioner of claim 9, wherein the elastic member insert recess is disposed between the interior circumference and exterior circumference of the base and the interior circumference and exterior circumference of the boss.

11. The variable tensioner of claim 10, wherein the elastic member is wound substantially around the interior circumference of the base and the interior circumference of the boss in the elastic member insert recess.

12. The variable tensioner of claim 1, wherein the tension actuator is provided with one end fixed to the base and the other end disposed in close proximity to a portion of the elastic member.

13. The variable tensioner of claim 12, wherein the tension actuator rotationally deforms the portion of the elastic member so as to enforce torsion moment when the tension actuator is activated.

14. The variable tensioner of claim 13, wherein the tension actuator is a piezoelectric element.

15. The variable tensioner of claim 1, wherein the engine control unit controls the tension actuator in a case that the engine speed is less than or equal to a predetermined speed so as to extend the tension actuator.

16. The variable tensioner of claim 15, further comprises a crank shaft position sensor detecting the phase angle of a crankshaft and sending the detected phase angle to the engine control unit to calculate the engine speed.

17. The variable tensioner of claim 16, wherein the predetermined engine speed is 2000 RPM.
